(19) United States
(12) Patent Application Publication
(10) Pub. No.: US 2026/0189062 A1
(43) Pub. Date: Jul. 2, 2026

(54) SYSTEMS AND METHODS FOR DETERMINING A TOPOLOGY OF AN ELECTRIC VEHICLE SUPPLY EQUIPMENT NETWORK

(71) Applicant: PowerFlex Systems, LLC, San Diego, CA (US)

(72) Inventors: Zachary LEE, Pasadena, CA (US); Steven LOW, La Cañada Flintridge, CA (US); George LEE, Los Altos, CA (US); Ted LEE, San Marino, CA (US)

(21) Appl. No.: 19/427,117

(22) Filed: Dec. 19, 2025

Related U.S. Application Data
(60) Provisional application No. 63/739,421, filed on Dec. 27, 2024.

(51) Int. Cl. H02J 13/12; H02J 7/90; H02J 13/13; H02J 13/182; H02J 105/37

(52) U.S. Cl. CPC H02J 13/12; H02J 7/90; H02J 13/1335; H02J 13/182; H02J 2105/37

(57) ABSTRACT

Certain aspects of the present disclosure provide techniques for determining a topology of an electric vehicle supply equipment (EVSE) network. An example method includes obtaining, for a first time period, for each of a plurality of pieces of equipment of the EVSE network, a respective magnitude of a respective current phasor, wherein for each of one or more pieces of equipment of the plurality of pieces of equipment, a respective phase angle of the respective current phasor is unknown; and determining, based on at least the respective magnitude of the respective current phasor for each of at least one piece of equipment of the one or more pieces of equipment, a respective subset of lines of the EVSE network to which the respective piece of equipment is coupled.

### CROSS-REFERENCE TO RELATED APPLICATIONS

This application claims the benefit of and priority to U.S. Provisional Patent Application No. 63/739,421, filed on Dec. 27, 2024, the entire contents of which are hereby incorporated by reference.

### INTRODUCTION

Electric vehicle (EV) charging infrastructure is a rapidly evolving field given the popularity of EVs. EV charging stations such as electric vehicle supply equipments (EVSEs) often rely on backend systems (e.g., local and/or cloud-based backend systems) to manage charging sessions. For example, when an EV connects to an EVSE, the EVSE sends a status update to a backend system, which then initiates and manages a charging session. The backend system maintains databases of active charging sessions across multiple sites and EVSEs. As the EV charging infrastructure evolves, an increasing number and/or type of energy assets that support these sites and EVSEs may lead to an increased level of complexity in how such energy assets are managed and controlled. The increased level of complexity in the management and control of the energy assets may be associated with various types of technical challenges. Accordingly, there exists a need for improvements in EV charging infrastructure to overcome these technical challenges. As the EV charging infrastructure continues to expand, such technical challenges are expected to affect more users.

### SUMMARY

Certain aspects provide a method for determining a topology of an EVSE network. The method includes obtaining, for a first time period, for each of a plurality of pieces of equipment of the EVSE network, a respective magnitude of a respective current phasor, wherein: for each of one or more pieces of equipment of the plurality of pieces of equipment, a respective phase angle of the respective current phasor is unknown; and determining, based on at least the respective magnitude of the respective current phasor for each of at least one piece of equipment of the one or more pieces of equipment, a respective subset of lines of the EVSE network to which the respective piece of equipment is coupled.

Other aspects of the present disclosure provide one or more processing systems configured to perform the aforementioned method as well as those described herein; one or more non-transitory, computer-readable mediums comprising instructions that, when executed by one or more processors of one or more processing systems, cause the one or more processing systems to perform the aforementioned method as well as those described herein; a computer program product embodied on a computer readable storage medium comprising code for performing the aforementioned method as well as those described herein; and a processing system comprising means for performing the aforementioned method as well as those described herein.

The following description and the related drawings set forth in detail certain illustrative features of one or more aspects.

### DESCRIPTION OF THE DRAWINGS

The aspects set forth in the drawings are illustrative and exemplary in nature and not intended to limit the disclosure. The following detailed description of the illustrative aspects can be understood when read in conjunction with the following drawings, where like structure is indicated with like reference numerals and in which:

FIG. 1 depicts an example computing environment for determining a topology of an EVSE network, according to aspects provided herein;

FIG. 2 depicts a software configuration for an example edge environment for determining a topology of an EVSE network, according to aspects provided herein;

FIGS. 3A-3C depict example device configurations for an edge environment for determining a topology of an EVSE network, according to aspects provided herein;

FIGS. 4A-4C depict example hardware components that may be utilized for the devices from FIGS. 3A-3C, according to aspects provided herein;

FIG. 5 depicts a software configuration for an example cloud environment for determining a topology of an EVSE network, according to aspects provided herein;

FIG. 6 depicts an example of an EVSE network, according to aspects provided herein;

FIG. 7 depicts an example of an EVSE network, according to aspects provided herein;

FIG. 8 depicts an example process flow for determining a topology of an EVSE network, according to aspects provided herein;

FIG. 9 depicts an example process flow for determining a topology of an EVSE network, according to aspects provided herein;

FIG. 10 depicts a method for determining a topology of an EVSE network, according to aspects provided herein; and

FIG. 11 depicts an example processing system configured to perform the methods described herein.

### DETAILED DESCRIPTION

Aspects disclosed herein include systems and methods for determining a topology of an EVSE network. Some aspects provide methods for automatically detecting a topology of an electrical network at a site, such as an EVSE network, based on measurements of the magnitude (e.g., amplitude) of current draw of individual components and measurements of line currents. Aspects of systems and methods for (e.g., automatically) determining a topology of an EVSE network, incorporating the same, will be described in more detail, below.

There are several technical challenges associated with determining a topology of an EVSE network. For example, certain systems and methods for load management of an EVSE network may require accurate network topologies including information relating to which electrical panel and/or electrical subpanel each piece of equipment is on and what phase angle (also referred to as phase) the current is of the line it is connected to. One way to gather this information may require a technician to manually document the topology of the EVSE network and store the documented information via a data storage system such as a database. For example, a technician may manually gather topology information of the EVSE network based on noting a breaker location on each electrical panel board. Such manual effort may be time-consuming and may delay, for example, an EVSE network commissioning process. Moreover, the manual effort in gathering, documenting, and storing the topology information of the EVSE network may be error-prone due to its manual nature. An operation of an EVSE network based on erroneous topology information may lead to various technical problems such as component overloads, and may cause breaker tripping or other problems.

Certain aspects of the present disclosure may (e.g., automatically) detect or determine a topology of an EVSE network (an example of an electrical network) based on data such as measurements of the magnitude of current draw of individual components and measurements of magnitude of line currents. For example, some aspects may determine a topology of an EVSE network by determining information regarding connection of EVSE(s) to one or more electrical panels and/or electrical subpanels based on measurements of the magnitude of current draw of individual components and magnitude of line currents. While certain aspects may be related to detecting or determining the connection of EVSEs, it would be apparent to one of ordinary skill in the art that certain aspects may also be used for detecting or determining the connection of any distributed energy resource (DER) where the magnitude of current draw may be measured, for example, by a meter.

Certain aspects of the present disclosure provide several technical benefits and advance the state of the art in determining a topology of an EVSE network and controlling the EVSE network accordingly. Topology information of an EVSE network may be used to enable safe load management of the EVSE network. Some aspects of the present disclosure may offer a number of significant advantages. For example, certain aspects may enable an automatic determination of a topology of an EVSE network based on data collected by one or more meters. The automatic determination of the topology of the EVSE network may reduce the time needed to commission a site and may reduce an amount of error associated with determining the topology of the EVSE network.

Some aspects of the present disclosure, of automatically determining the topology of the EVSE network, may be performed periodically for an EVSE network, which enables detection of changes in the topology of the EVSE network over time. For example, if an EVSE is added or replaced in the EVSE network, the logical location of the added or replaced EVSE may be detected automatically, enabling an accurate knowledge of the topology of the EVSE network at a given point in time. The accurate knowledge of the topology of the EVSE network may provide several technical benefits, such as an increased charging rate or throughput for the EVSE network and reduced downtime. For example, the EVSE network may be operated closer to any limit associated with a given portion of the EVSE network (e.g., as compared to when the knowledge of the topology of the EVSE network is less accurate), without increasing the risk of any hazard relating to potentially overloading an electrical component in the EVSE network.

Further, certain aspects of the present disclosure may allow for determination of a topology of an EVSE network based on measurements of the magnitude of current in the EVSE network, such as without measurements of current phase in the EVSE network, or with limited measurements of current phase in the EVSE network. In particular, many pieces of equipment in an EVSE network, such as many chargers, may not have current phase measurement capabilities due to the complex circuitry required for enabling phase measurement. Certain aspects described herein provide techniques to enable determination of a topology of an EVSE network without such current phase measurements, or with only limited current phase measurements. Other techniques may require full current phase measurement information for each piece of equipment, which may not be technically feasible.

For example, each piece of equipment and each line coupling equipment within the EVSE network may have current output by the equipment, current input to the equipment, or current carried by the line. A current phasor of such current may include a magnitude of the current phasor corresponding to a magnitude of the current and a phase angle of such current phasor corresponding to a phase angle of the current. In certain aspects, the magnitude of the current phasor may be more easily measurable than the phase angle of the current phasor, where some aspects may provide techniques to determine a network topology without requiring full phase angle of current information for the EVSE network. As an example, certain techniques may not utilize any phase angle of current measurements for any pieces of equipment in the EVSE network. Certain techniques may utilize only phase angle of current measurements for (e.g., only) some pieces of equipment in the EVSE network, such as phase angle of current measurements of lines only (but not of certain pieces of equipment, such as chargers). In certain aspects, the techniques discussed herein may be used to determine where in the network topology a piece of equipment is without phase angle of current measurements for the piece of equipment.

### Example Computing Environment

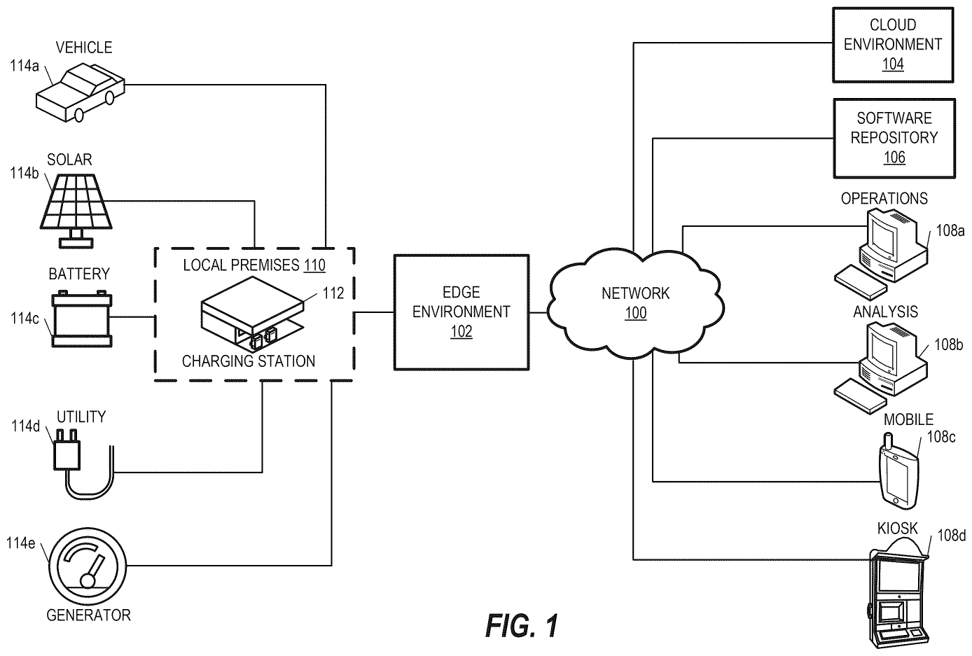

Referring now to the drawings, FIG. 1 depicts an example computing environment for determining a topology of an EVSE network, according to aspects provided herein. As illustrated, the computing environment includes a network 100 that is coupled to an edge environment 102, a cloud environment 104, a software repository 106, as well as one or more ancillary devices 108 (including an operations device 108a, an analysis device 108b, a mobile device 108c, and/or a kiosk device 108d). The network 100 may be configured as any wide area network (WAN, such as the internet, power network, cellular network, etc.) or other network for facilitating communication among the edge environment 102, the cloud environment 104, the software repository 106, and the ancillary devices 108.

Edge environment 102 may generally be deployed at a local premises site 110 (also referred to herein as a site) to provide various services, including coordination and optimization of one or more energy assets 114 (including an EV 114a, a solar device 114b, a battery energy storage system (BESS) 114c, a utility grid 114d, and/or a generator 114e), such as charging of electric vehicles (e.g., EV 114a) using charging station 112 and controlling one or more of various distributed energy resources (DERs), such as solar device 114b, BESS 114c, utility grid 114d, and/or generator 114e (e.g., an on-site diesel, natural gas, or other type of fueled generator). Generally, the aforementioned DERs may provide energy to the charging station 112 and/or use energy from the charging station 112 (e.g., by way of a backflow of energy from EV 114a to other aspects of site 110). In some aspects, charging station 112 may send excess energy back to the BESS 114c and/or to utility grid 114d. Generally, edge environment 102 may monitor and/or modify the energy sent to and received from the DERs to optimize various tasks, such as charging of EV 114a.

Charging station 112 may utilize one or more of various communication protocols, such as open smart charging protocol (OSCP), open charge point interface (OCPI), ISO 15118, OpenADR, open charge point protocol (OCPP), etc. and may represent Level 1, Level 2, Level 3 (e.g., DC Fast Charging), and higher level charging stations, as applicable. Generally, the “level” of a charging station refers to the power level and/or ability to provide electric power to a device being charged.

Edge environment 102 is configured as an interface between various aspects of site 110 and network 100. In various aspects, compute resources for performing different functions at a site, such as control or optimization of EV charging, may be split between local compute resources in edge environment 102 and remote compute resources, e.g., in cloud environment 104 of FIG. 1.

Cloud environment 104 is coupled to the edge environment 102 via the network 100 and may be configured for further processing of data, as described herein. While FIG. 1 depicts a single cloud environment 104 that serves a single edge environment 102, this is merely an example, as some aspects may be configured such that the cloud environment 104 may serve a plurality of edge environments 102 that each serve one or more sites 110, one or more charging stations 112, one or more DERs, and the like.

Software repository 106 is also coupled to site 110 via network 100. Software repository 106 may be configured as a platform to program, store, manage, control changes, etc. to software that is implemented in edge environment 102 and/or cloud environment 104. In some aspects, software repository 106 may be configured as a proprietary service and/or may be provided by a third-party, such as GitHub™. Additionally, some aspects may be configured such that the software repository 106 is provided by the same entity that manages the cloud environment 104. As such, these aspects may be configured such that software repository 106 and cloud environment 104 may be combined.

With respect to the ancillary devices 108, the operations device 108a may be utilized to monitor and/or alter operations of the computing environment provided in FIG. 1. The analysis device 108b may analyze utilization, operation, charging, and/or other features of the computing environment provided in FIG. 1. The mobile device 108c may represent an administrator device and/or a user device. As a user device, the mobile device 108c may initiate charging, perform payment, and/or perform other user-specific actions. As an administrator device, the mobile device 108c may perform administrative operations, analysis, and/or other actions. The kiosk device 108d may be located at one of the charging stations 112 and/or remote therefrom and may provide user-specific or administrative actions, similar to that of the mobile device 108c. In some aspects, one or more administrators may use the kiosk device 108d to view information about a site or make changes. As will be understood by one of ordinary skill in the art, the ancillary devices 108 may each include one or more processors, one or more memory components, and/or other hardware and/or software for performing the functionalities provided herein. It should be understood that while the kiosk device 108d is depicted as being remote from the site 110, some aspects may not be configured in this manner. Specifically, some aspects may utilize a kiosk device 108d that is local at the site 110, which may communicate via a local network and/or the network 100 for providing the services described herein.

### Example Edge Environment

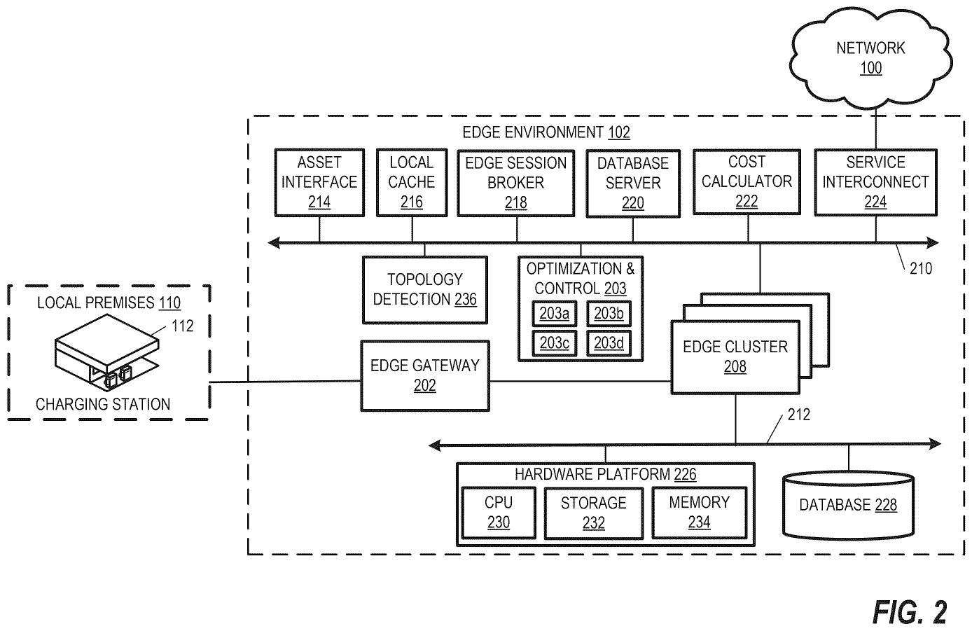

Referring now to FIG. 2, the edge environment 102 may be coupled to the site 110 via an edge gateway 202. Edge environment 102 may be operatively coupled to aspects of site 110, such as charging station 112 via edge gateway 202. Edge environment 102 further includes an edge cluster 208, which is coupled to communication bus 210 and hardware bus 212. Communication bus 210 is coupled to optimization and control manager 203, asset interface 214, local cache 216, edge session broker 218, database server 220, cost calculator 222, and service interconnect 224 in this example. In certain aspects, communication bus 210 is also coupled to a topology detection component 236 (e.g., server). Hardware bus 212 is coupled to hardware platform 226, which may include one or more processors, such as CPU 230, one or more storage components 232, one or more memory components 234, and/or other hardware components. Also coupled to hardware bus 212 is database 228. Though certain components (e.g., cost calculator 222, database server 220, etc.) of edge environment 102 are depicted separate from hardware platform 226, they may be services or processes configured to run on hardware platform 226. Further, though certain components are illustrated as separate components, the functionality of such components may be combined into a single component and/or further divided among additional components.

Communication bus 210 and hardware bus 212 may be utilized to facilitate operation of all services that run in edge environment 102 and communicate with each other via a distributed message streaming system. The coupling of the aforementioned services may be accomplished in some aspects via a distributed message streaming system, such as NATS.

In the depicted example, charging station 112 is configured for communication with edge environment 102 via edge gateway 202, such as via a short-range wireless network technology, such as via a Zigbee® PAN. The edge gateway 202 may be configured to receive data, such as electric vehicle charging data, price change data, vehicle data, etc. from the charging station 112 and/or vehicles that are being charged via the connection with the site 110 (of FIG. 1).

In some aspects, edge gateway 202 may be configured to abstract data received from various aspects of site 110 (of FIG. 1), such as charging station 112, to remove protocol-specific distinctions. For example, a first charging station may utilize a first communication protocol and/or billing protocol and a second charging station may utilize a second communication protocol and/or billing protocol. Edge gateway 202 may receive data packets from both the first charging station using the first communication protocol and the second charging station using the second communication protocol and may transform the received data into a protocol-agnostic format prior to providing the data to edge cluster 208. This may allow wide interoperability between edge environment 102 and various types of hardware (e.g., charging station 112) at a site.

Edge cluster 208 is the central message center in various aspects. For example, when a user plugs a vehicle into a charging station 112, edge cluster 208 receives data from edge gateway 202, parses that data (e.g., to generate access state data) and causes the state data to be sent to the database server 220. Edge cluster 208 also receives the data and creates a session entry, which may be stored in the local cache 216. Edge cluster 208 may additionally send the session entry to the cloud environment 104 (of FIG. 1) via network 100. Edge session broker 218 may also receive data related to the new session and may query database server 220 to access additional session data to determine charging characteristics for charging station 112.

The edge session broker 218 may produce data or signals that are sent to the edge cluster 208, which may be sent to the edge gateway 202 for potentially sending back to one or more of the charging stations 112. Information that may be reported might include current delivered over time (e.g., amperes), total energy delivered (e.g., kWh), power delivered over time (e.g., kW), voltage at the charging station over time (e.g., V), charging station state (e.g., connected, disconnected, offline), connectivity state, charging state, etc. The charging stations 112 may report any errors back to the edge cluster 208. The cost calculator 222 may be engaged to access pricing data from the cloud environment 104 and may calculate costs incurred based on delivered energy, expected costs prior to charging, idle time interval, parking time interval, etc. The asset interface 214 may be a software interface between the edge environment 102 and the energy assets 114.

Edge cluster 208 may be configured such that any message received by the edge cluster 208 may also be sent to the cloud environment 104 (of FIG. 1) for consumption by a data subscriber in the cloud environment 104. For example, if a user of the mobile device 108c (in FIG. 1) desires to claim a charging session, mobile device 108c does not need to access edge environment 102 directly. Instead, mobile device 108c may connect with the cloud environment 104 (of FIG. 1), which sends a message to the edge cluster 208 with an instruction to claim the session. Service interconnect 224 is configured for establishing an HTTP, TCP, and/or other type of communication with the cloud environment 104 (of FIG. 1) via network 100.

The optimization and control manager 203 may provide energy optimization and adaptive load management (ALM) functions, for example, for various energy assets 114 at the site 110 (of FIG. 1). For example, the optimization and control manager 203 may be responsible for calculating set-points for each asset for the energy optimization and ALM amongst the energy assets 114 and providing data related to the calculated set-points to the asset interface 214. A set-point may be a value for a parameter (or a set of values for a set of parameters), such as a charging rate. In certain aspects, the optimization and control manager 203 may include a database layer 203a to store data related to site configurations; an orchestration layer 203b to gather data, trigger optimizations, and/or issue set-points (e.g., provide the calculated set-points to energy assets); an optimization layer 203c to formulate and solve optimization problems to calculate set-points; and/or a control layer 203d for higher frequency feedback based controls (e.g., for modifying set-points to respond to fast time-scale events).

Optimization and control manager 203 may determine when optimization set-points need to be updated. Examples of when optimization set-points need to be updated include, but are not limited to: (1) when a new energy asset is installed at a site, (2) when a new vehicle to be charged arrives at a site, (3) when a measured value such as load or generation changes, (4) when a system parameter such as the target energy for a vehicle is updated, (5) when an external event occurs (such as a demand response event), and/or (6) at a fixed cadence (e.g., every 5 minutes). When it is determined that the optimization set-points need to be updated, optimization and control manager 203 may collect data needed for optimization, including optimization configuration from the cloud environment 104 of FIG. 1 (which can also be cached at edge environment 102) and state information from edge environment 102 and/or cloud environment 104. Examples of the optimization configuration include, but are not limited to: network and equipment constraints, optimization parameters such as the precision and timeout settings, etc. In certain aspects, the state information from edge environment 102 and/or cloud environment 104 includes the states of the energy assets, as well as other state information including EV driver preferences, price signals, and grid signals. Further, optimization and control manager 203 may perform optimization to calculate new/updated set-points. In certain aspects, optimization and control manager 203 may (e.g., optionally) run a fast time-scale control loop which adjusts set-points in real-time in response to fast changing signals, such as building load, solar generation, or grid signals. In some aspects, the functionalities of the optimization and control manager 203 may be implemented, at least in part, within the cloud environment 104 (of FIG. 1).

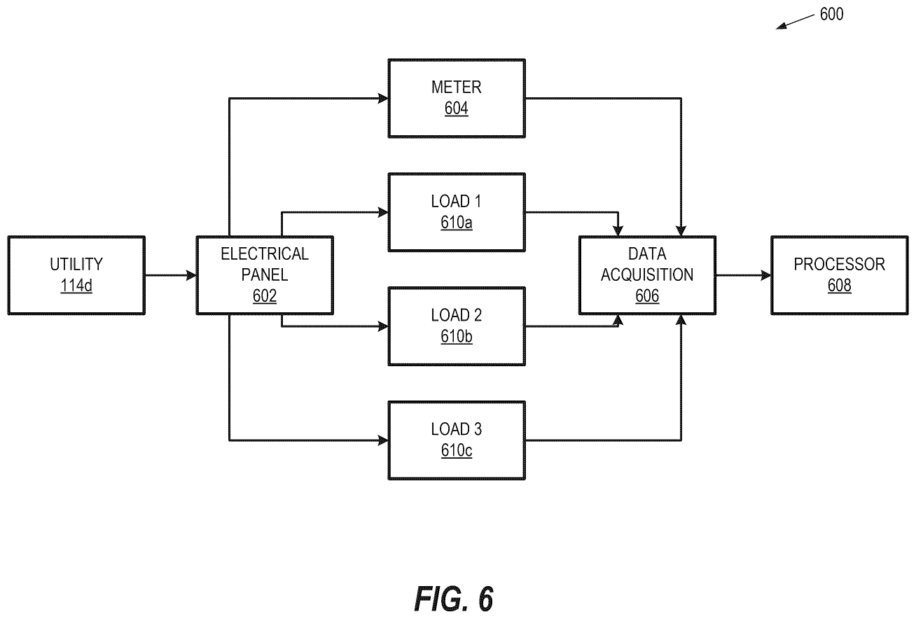

In certain aspects, the topology detection component 236 may implement one or more functions of a topology detection system that is described further herein with reference to, for example, FIGS. 6-9 by utilizing one or more components of the edge environment 102 described herein. In some aspects, the topology detection system may utilize one or more components and/or compute resources of the edge environment 102 and/or one or more components and/or compute resources of the cloud environment 104 to implement its functions or other compute resources. In some aspects, the topology detection system may utilize one or more components and/or compute resources of one or more separate computing devices to implement its functions or other compute resources.

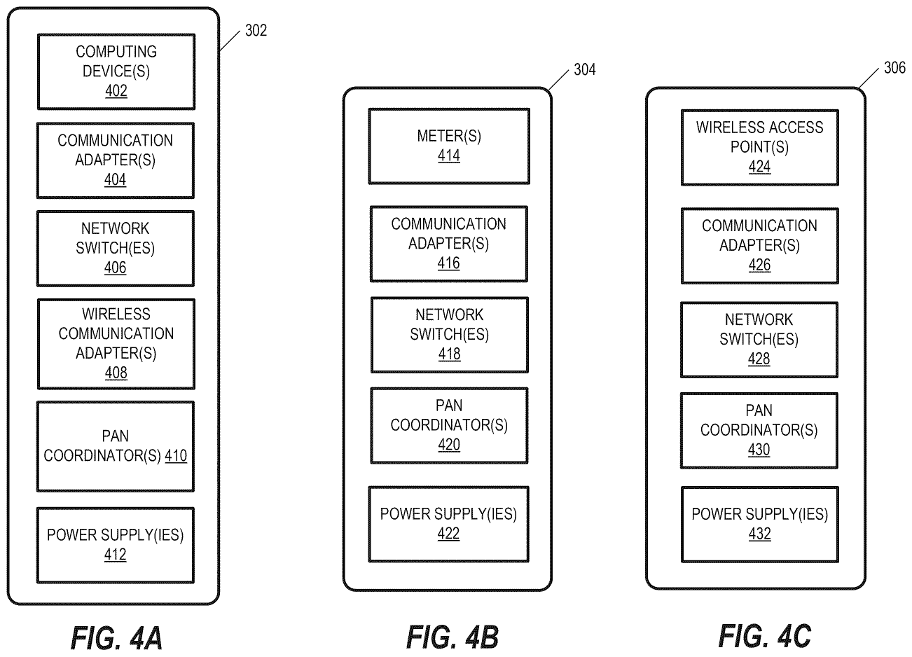

Hardware platform 226 represents any hardware for facilitating the processes and actions described herein. Specifically, one or more CPUs 230 may represent one or more types of processing device configured for executing instructions. One or more storage components 232 may be configured as long term storage, such as a hard drive or the like. One or more memory components 234 may include any of various types of random access memory or the like. One or more databases 228 may be configured for additional storage and may be housed with the other hardware and/or elsewhere. Examples of different hardware platforms that may be deployed in edge environment 102 are described further below with respect to FIGS. 4A-4C.

### Example Hardware Configurations for Edge Environment

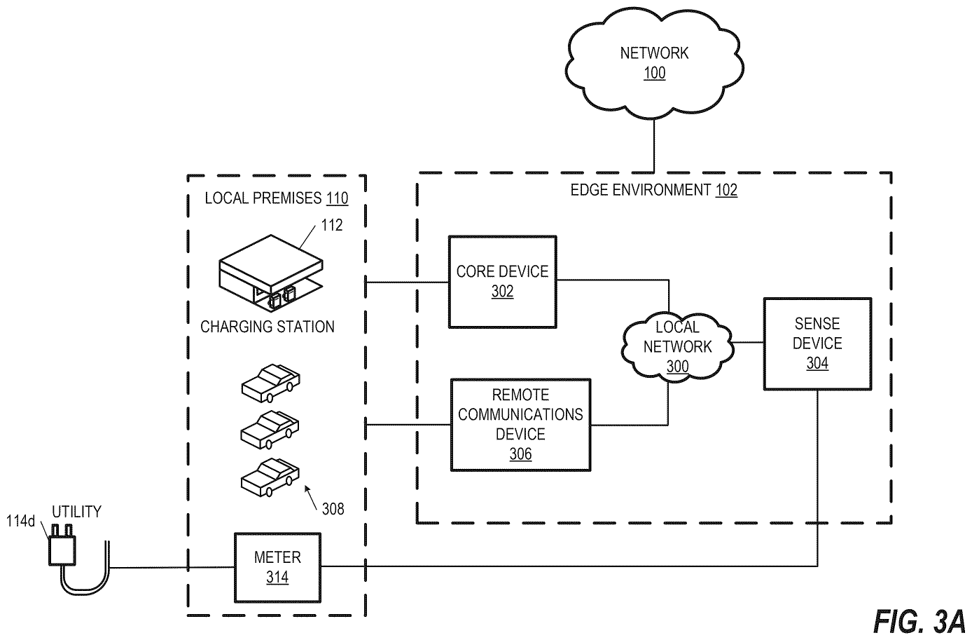

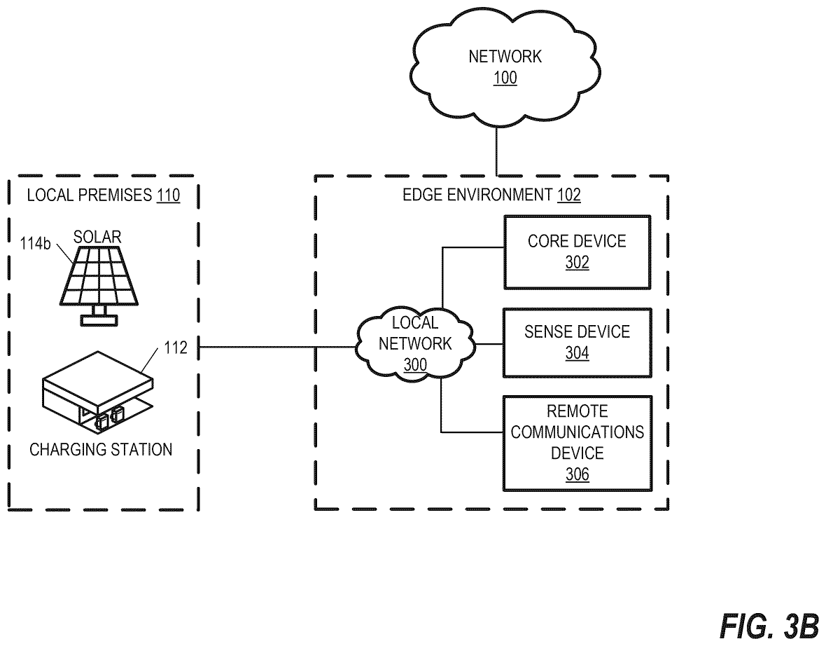

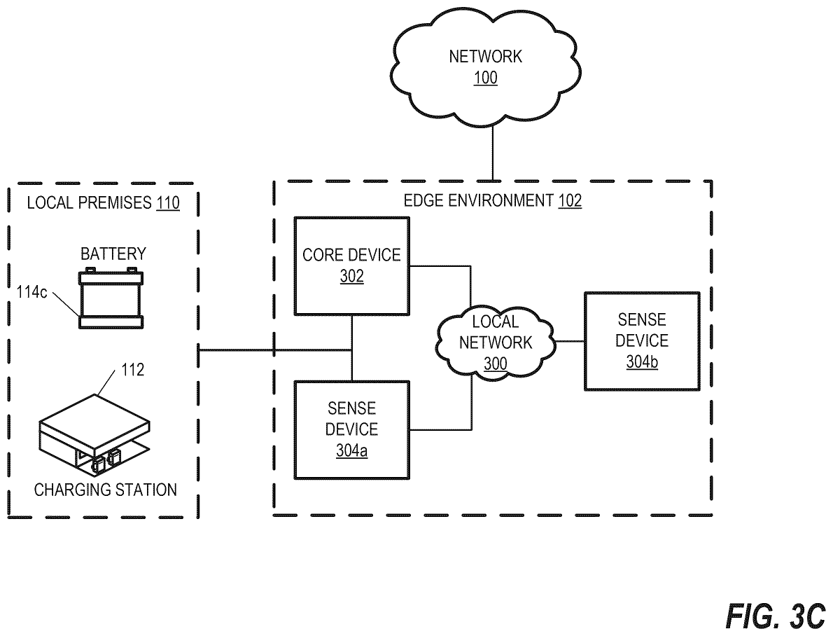

FIGS. 3A-3C depict example device configurations for edge environment 102, according to aspects provided herein. Specifically, FIG. 3A depicts a charging solution. As illustrated, the charging station 112 is coupled to a local network 300 via a core device 302. The local network 300 may include any local area network, Ethernet, PAN, etc. The core device 302 may be physically installed within communications range of one or more chargers in the charging station 112. A sense device 304 may be installed, for example, in an electrical room or in another enclosure with electrical equipment of the charging station 112 and/or one or more energy assets 114 to monitor the main metering point for the local utility point of common coupling. This may enable one or more algorithms to provide the optimal dispatch of EV charging power, subject to local energy rates and the vehicles currently charging. In the case that there are vehicles 308 using EV chargers that are out of communications range of the core device 302, such as a sub-level of a parking garage, one or more remote communications devices 306 may be included. In certain aspects, at least one of the one or more remote communications devices 306 may be in data communication with the charging station 112 (e.g., having one or more EV chargers charging one or more vehicles 308) and/or vehicles 308. Also included at the site 110 is a meter 314 for communicating energy with the utility grid 114d.

The core device 302 shown in FIG. 3A is the central processing device and serves as the communications hub. In certain aspects, the components of FIG. 2 may generally operate, at least in part, as part of the core device 302. The core device 302 may provide optimization, load management, communication coordination, topology detection, and/or data historian services. The core device 302 may communicate with the cloud environment 104 via cellular modem, wired internet service provider (ISP), and/or other communications medium to get current optimization and load management set-points for charging stations 112 and/or other assets, such as via an optimization algorithm that may be stored locally and/or at the cloud environment 104. It will be understood, however, that some aspects may be configured such that the core device 302 performs optimization locally. In certain aspects, the core device 302 dispatches these set-points, through a local communications protocol (e.g., Wi-Fi) and/or via the remote communications device 306 to reach locations that are distant or hard to reach, such as charging stations with a core device 302 and/or sense device 304 at sub-levels of a parking garage or a rooftop solar inverter. The core device 302 may additionally or alternatively collect data directly from distributed energy resources and power measurement devices or through cloud-based communications with the network 100.

Power and energy metering data may be collected via the sense device 304. The sense device 304 may include a smart meter with support for multiple single- and three-phase loads, such as with a local historian and Ethernet communication back to the device via the local network 300. The sense device 304 may also incorporate support for additional devices running on the edge including but not limited to thermocouple wiring, weather stations, temperature sensors, pyranometers, etc. It should be noted that additional sense devices 304 and remote communications devices 306 can be added to handle a variety of situations, such as a separate subpanel for energy metering of a new solar system or for monitoring of a new inverter associated with a rooftop solar installation.

FIG. 3B depicts a solar application where the core device 302 and the sense device 304 are installed in an electrical room or other common area. The sense device 304 can monitor the main metering point for the local utility as well as the solar production at tie-in breakers for the solar device 114b. The remote communications device 306 may be installed in a position to communicate directly with the solar device 114b and report the data received from the solar device 114b to the core device 302. Accordingly, the core device 302, the sense device 304, and the remote communications device 306 depicted in FIG. 3B may perform similar functions as those devices depicted in FIG. 3A.

FIG. 3C depicts a battery application where the core device 302 and the sense device 304 (including a first sense device 304a and a second sense device 304b) are installed physically near the BESS 114c. In some cases where the BESS 114c is near the point of common coupling with the utility grid 114d, a single sense device 304a can monitor the full site. In some cases where there is a significant distance to the metering point for the utility grid 114d, the second sense device 304b (or a plurality of second sense devices 304b) may be installed near the utility meter, such as the electrical room.

### Example Hardware Components in Core, Sense, and Remote Communications Devices

FIGS. 4A-4C depict example hardware that may be utilized for the devices from FIGS. 3A-3C, according to aspects provided herein. Specifically, FIG. 4A depicts hardware components that may be present in core device 302. In some aspects, the core device 302 is the brain where the energy optimization and adaptive load management (ALM) functions (e.g., by the optimization and control manager 203 of FIG. 2) and/or topology detection are executed and dispatched. As illustrated, the core device 302 may include one or more computing devices 402, one or more communication adapters 404, one or more network switches 406, one or more wireless communication adapters 408, one or more PAN coordinators 410, and/or one or more power supplies 412. As will be understood, the computing device(s) 402 may include one or more processors, one or more memories, and/or other components that a conventional, specific-purpose machine may utilize. In some aspects, the computing device(s) 402 may include power line communication (PLC) infrastructure, while some aspects may utilize retail and/or micro-industrial computer components for optimization, load management, communication coordination, and/or historian services.

The communication adapter(s) 404 may be configured for load balancing and otherwise managing communications of, for example, Modbus RTU (RS485) to Modbus TCP (Ethernet) or Ethernet IP (RJ45) to Ethernet Optical (SFP), etc. The network switch(es) 406 may be configured for routing of network traffic, and may be configured as an Ethernet switch for communication to other nodes (e.g., the sense device 304, the remote communications device 306, and/or other core device 302), distributed energy resources, and/or energy based management systems.

The wireless communication adapter(s) 408 may include a cellular modem, internet modem, Wi-Fi access point, etc. for facilitating wireless communications to the internet or other wide area network. Similarly, the PAN coordinator(s) 410 may be configured to create and/or join communication connections with other devices. This may include a Zigbee coordinator, Bluetooth device, and/or other device for performing this function. The power supply(ies) 412 may be configured as battery power, connection to external power, etc.

FIG. 4B depicts hardware components of the sense device 304 from FIGS. 3A-3C. The sense device 304 may be configured as a smart-metering piece for collection and storage of power/energy data such as measurements such as temperature, voltage, current, power, solar irradiance, wind speed, etc. The sense device 304 may include a smart meter with multiple channels of measurement that may comprise single-phase circuits and/or three-phase circuits. The sense device 304 may communicate meter data back to the core device 302 from meter locations such as electrical rooms, rooftop solar installations, EV chargers, and subpanels. Certain aspects may be optimized for ease of installation and reduced intrusion to the site. Power over Ethernet (PoE) sourced from the core device 302 may suffice for most installations. The sense device 304 may transmit data back to the core device 302 via a network switch. The sense device 304 may be optimized to utilize minimal power, and PoE may be acceptable for most installations.

As illustrated in FIG. 4B, the sense device 304 includes one or more meters 414, one or more communication adapters 416, one or more network switches 418, one or more PAN coordinators 420, and/or one or more power supplies 422. The power supply(ies) 422 may include a power interface for providing power to the sense device 304. In certain aspects, the meter(s) 414 may be power meter(s) utilized for monitoring single-phase and three-phase loads of power. The communication adapter(s) 416 may be utilized for facilitating communications between the sense device 304 and other devices. The network switch(es) 418 may be a PoE enabled switch for communication. Similarly, the PAN coordinator(s) 420 may create and/or join personal area networks, such as via Zigbee, Bluetooth, and the like. In some aspects, PoE or other power source may be utilized.

As illustrated in FIG. 4C, the remote communications device 306 may be a network-connectivity extension, for example, for EV charging or solar monitoring locations where Zigbee, Wi-Fi, or Ethernet is being extended to remote or difficult-to-reach locations such as remote subpanels, parking garage levels, or rooftop inverters. Some aspects are optimized for ease of installation and reduced intrusion to the site where PoE may suffice for most installations from the core device 302. The remote communications device 306 may be configured to transmit data back to the core device 302 via a network switch.

Specifically, the remote communications device 306 may include one or more wireless access points 424, one or more communication adapters 426, one or more network switches 428, one or more PAN coordinators 430, and/or one or more power supplies 432. The wireless access point(s) 424 may be configured to extend wireless communication signals to chargers and/or other intelligent electronic devices. The communication adapter(s) 426 may be configured for facilitating communications between the remote communications device 306 and other devices. The network switch(es) 428 may be configured as a PoE Ethernet switch and/or other network switch for communicating with the core device 302. The PAN coordinator(s) 430 may be configured to create and/or join personal area networks, such as via Zigbee, Bluetooth, and the like. The power supply(ies) 432 may include a power interface for providing power to the remote communications device 306.

### Example Cloud Environment

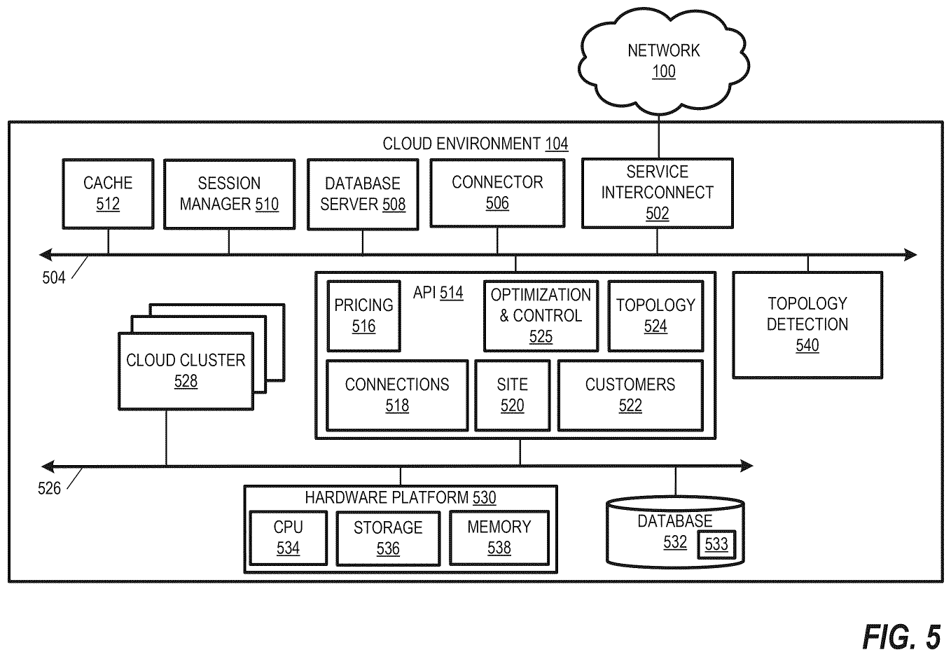

FIG. 5 depicts an example cloud environment for determining a topology of an EVSE network, according to aspects provided herein. As illustrated, the network 100 may couple to the cloud environment 104 via a service interconnect 502 that corresponds with the service interconnect 224 from FIG. 2. Similar to the service interconnect 224 from FIG. 2, the service interconnect 502 may be configured to facilitate an HTTP, TCP, and/or other communication portal through the network 100 to the edge environment 102 for the exchange of data between the edge environment 102 and the cloud environment 104. Additionally or alternatively, the service interconnect 502 may be configured to facilitate an HTTP, TCP, and/or other communication portal through the network 100 directly with an electric vehicle supply equipment (EVSE), such as charging station 112, for the exchange of data between the edge environment 102 and the EVSE. For example, in some such aspects, cloud environment 104 may be configured with the same or similar components as edge environment 102 (e.g., in addition or alternative to one or more components shown in FIG. 5) and configured to perform functions similar to edge environment 102, such that a separate edge environment 102 may not be needed.

The service interconnect 502 is coupled to a communication bus 504, which facilitates communication among various components of FIG. 5. Also connected to the communication bus 504 are a NATS connector 506, a database server 508, a session manager 510, a cache 512, a collection of services and application programming interfaces (APIs) 514, and a topology detection component 540. The APIs 514 may include a pricing API 516, a connections API 518, a site API 520, a customers API 522, a topology API 524, and/or an optimization and control API 525. The APIs 514 may be implemented by hardware platform 530. Hardware bus 526 is coupled to a NATS cloud cluster 528, as well as the hardware platform 530 and a database 532. The hardware platform 530 may include one or more CPUs 534, one or more storage components 536, and one or more memory components 538. Though certain components of cloud environment 104 are depicted separate from hardware platform 530, they may be services or processes configured to run on hardware platform 530. Further, though certain components are illustrated as separate components, the functionality of such components may be combined into a single component and/or further divided among additional components.

The APIs 514 is a component of the cloud environment 104. As such, the APIs 514 (including the pricing API 516, the connections API 518, the site API 520, the customers API 522, the topology API 524, and/or the optimization and control API 525) may cause storage of and/or process site information, site topology, customers, connections to panels, constraints of panels, pricing information of each site, local forecasting services, optimization services, controller services, caching services, etc. The APIs 514 may also serve as a mobile backend by storing personal information of charge users (e.g., email, charging preferences, payment preferences, privileges, access, fleet information, etc.). The APIs 514 may additionally store peak charging configurations, data related to meter setup, etc. In some cases, the APIs 514 may also be responsible for tracking changes to EVSE connections and causing related changes to various types of data. For example, a newly connecting EVSE may create a new charging session, and a newly disconnecting EVSE may close a charging session. The connection and the disconnection may cause changes in payment information for user(s) of the connecting or disconnecting EVSE(s), for example, related to payment for energy usage. In some aspects, the pricing API 516 may be used for storing information related to pricing configuration of a charging site, such as the site 110 (of FIG. 1). Some examples of the information related to pricing configuration of a charging site may include, but not be limited to, cost for energy (e.g., $/kWh), cost for parking time (e.g., $/time-interval), cost for idle parking time (e.g., $/idle-time-interval), etc. In certain aspects, the site API 520 may be or include a service that provides an API to read or change information about a charging site (e.g., site name, address, etc.). The topology API 524 may be used for storing information related to topology of EVSEs, and may be utilized to track, for example, which EVSEs are connected to which electrical panels and whether any electrical panels may be subpanels of other panels. Such information may be utilized for load management. For example, the topology API 524 may be used to implement one or more functions associated with the topology detection component 540 and/or the topology detection system that is described further herein with reference to, for example, FIGS. 6-9 In some aspects, the optimization and control API 525 may be responsible for handling optimization requests, performing one or more optimization methods, and communicating the result of the optimization. For example, the optimization and control API 525 may be or include a service that may be executed when there is a newly connected or disconnected EVSE, such that an optimization may be performed to allocate (e.g., re-allocate) power according to updated state(s) of the EVSE(s). In some aspects, optimization and control API 525 may enable per-site configuration of the optimization and control parameters. For example, these parameters can be updated via API(s) 514 (e.g., optimization and control API 525) directly or via a front-end interface. These parameters may include different parameters for each optimization strategy as well as the grouping of strategies into stages. Moreover, optimization and control API 525 may be used to store (e.g., via database 532) input and output pairs (e.g., related to various optimization scenarios, where an input may correspond to a combination of the optimization configuration and system state and an output may correspond to a collection of parameters for how the system should operate, etc.) for subsequent analysis.

When a vehicle is plugged into a charging station 112 (FIG. 1), the edge session broker 218 (FIG. 2) may communicate connection information to the APIs 514. The connection information may include vehicle information, user information, charging station information, etc. The APIs 514 then create a charge session object, which is stored in the cache 512. The cache 512 sends the session data, along with topology constraints and the charge session object to the edge environment 102. The NATS connector 506 may additionally cause the NATS cloud cluster 528 to maintain the charge session object for retrieval by an interested party. As the session continues, the session manager 510 may be utilized to alter constraints of the session, which may cause the NATS cloud cluster 528 to update the charge session object.

When a user claims a previously created session with the mobile device 108c, the database server 508 may create a database entry (e.g., within the database 532) with the charge session, driver, energy request, willingness to pay, electricity purchased, etc. The NATS connector 506 may update the NATS cloud cluster 528 with the database entry. This data may then be sent to the edge environment 102. When the charge session ends (e.g., when the vehicle is unplugged), that action may be added to the database entry and the database entry may be moved from a current sessions list to a completed sessions list.

In certain aspects, the database 532 may include optimization data 533 related to, for example, optimization scenarios (e.g., past optimization scenarios which may be used for debugging and/or auditing the performance of a given optimization scheme).

As indicated above, the hardware platform 530 may represent hardware that may be utilized to execute the components described regarding FIG. 5. As such, the CPU(s) 534 may be configured as any processing unit for receiving and executing computer-readable instructions. The storage component(s) 536 may be configured as any hard drive or other local storage device. The memory component(s) 538 may be configured as any type of RAM, ROM, registers, etc. or the like.

In certain aspects, the topology detection component 540 may implement one or more functions of the topology detection system described herein with reference to, for example, FIGS. 6-9, below.

### Example Topology Detection Systems and Methods

Certain aspects of topology detection systems and methods are described with reference to FIGS. 6-9. Some aspects may utilize an edge computing environment (e.g., one or more components, such as topology detection component 236, of the edge environment 102 described herein with reference to FIG. 2) and/or a cloud computing environment (e.g., one or more components, such as topology detection component 540, of the cloud environment 104 described herein with reference to FIG. 5), to detect or determine a topology of an EVSE network. Some aspects may utilize one or more other computing resources, such as a processing system (e.g., one or more servers) including one or more processors and one or more memories, the processing system configured to perform one or more aspects of techniques discussed herein.

In certain aspects, automatic or adaptive load management functions (e.g., as described herein) may utilize and/or rely on a circuit topology of a site, for example, relating to which line each piece of equipment is connected to, and as a result, the phase angle of that piece of equipment. Collecting this data manually (e.g., by a technician) may be time-consuming and error-prone. Thus, certain aspects of the present disclosure may use a data-driven approach to automatically identify or detect, for example, the connectivity of an EVSE network. Using a data-driven approach to automatically identify or detect the connectivity of an EVSE network may reduce the time and effort used to, for example, install EVSE projects or commission EVSE charging sites, and may reduce the rate of errors in connectivity data. Accordingly, certain aspects of the present disclosure may provide one or more technical advantages or benefits in reduced installation and support costs and commissioning time, as well as increased charging rate or throughput.

In certain aspects, a topology of an EVSE network may be determined by a mathematical modeling, which may be used for solving for or estimating the topology of the EVSE network (e.g., connectivity information of each piece of equipment, etc.). In some aspects, current magnitude (e.g., a magnitude of a current phasor) may be measured at one or more (e.g., each and all) pieces of equipment (e.g., EVSE or DER) and at one or more (e.g., each and all) lines, for example, by a respective meter installed and configured to measure the magnitude of the current phasor. In some aspects, with respect to the mathematical modeling, it may be assumed that (1) voltage phase angles are known and balanced and (2) loads (e.g., pieces of equipment, such as EVSEs or DERs) have unity power factor.

Moreover, the following notations are used to describe the mathematical modeling. N is the number of pieces of equipment. L is the number of lines. Iᵢ(t) is the current phasor at piece of equipment i at time t. The matrix I∈ [symbol] ^{T×N} may be used herein, which is the matrix of all currents at each time. Mⱼ(t) is the current phasor at line j at time t. The vector Mⱼ∈ [symbol] ^{T} may be used herein, which is the vector of currents for line j at each time. These values may be arranged into a matrix M∈ [symbol] ^{T×L}. Aᵢⱼ is matrix of coefficients that maps the current phasor at piece of equipment i to the current phasor at line j such that Mⱼ(t)=ΣᵢAᵢⱼIᵢ(t). The connectivity matrix can be written as A∈ [symbol] ^{N×L}. |⋅| is the magnitude of a complex number. When applied to a matrix or vector, it is the magnitude of each element. For example, |/| is a magnitude of the current phasor at a piece of equipment and |M| is the magnitude of all current phasors.

In certain aspects, given |I|∈ [symbol] ^{T×N} and |M|∈ [symbol] ^{T×L}, the methods described herein may be used to find the matrix Aᵢⱼ∈ [symbol] ^{N×L}.

In some aspects, where the current phasor at each piece of equipment and each line may be known, Aᵢⱼ may be solved for by solving the following linear system:

$${M}_{j} = \begin{matrix}{IA}_{j} & ∀ j\end{matrix} \qquad ( 1 )$$

If there is no noise, and I is invertible (e.g., t=j and I is full rank), then the system may be solved exactly by using:

$${A}_{j} = \begin{matrix}{I}^{- 1} {M}_{j} & ∀ j\end{matrix} \qquad ( 2 )$$

In certain aspects, there may be noise in the measurements. The noise can be addressed by requiring t>>j and solving an overdetermined system using the Moore-Penrose inverse, commonly known as the “pseudo-inverse”. This is the property of finding the least squares solution to the regression problem, for example, Aⱼ which solves the problem min_{A}_{ⱼ}∥I^{T}Aⱼ−Mⱼ∥. This yields:

$${A}_{j} = \begin{matrix}{I}^{†} {M}_{j} & ∀ j\end{matrix} \qquad ( 3 )$$

In some aspects, the complete phasor at each line may be known, while only the magnitude of the current drawn by each EVSE may be known. For example, there may be more advanced metering at the line level, but only basic onboard metering on each EVSE. In certain aspects, the following expanded version of the linear system may be considered by dividing I into its magnitude and phase angle. It may be assumed that the phase angle is approximately fixed. For example, it may be assumed that the voltage phase angles from the grid are roughly balanced and the EVSEs have approximately unity power factor.

$${M}_{j} = {\sum }_{i} {A}_{ij} \vert {I}_{i} \vert \begin{matrix}{e}^{j {θ}_{i}} & ∀ j\end{matrix} \qquad ( 4 )$$

Here, the following matrix may be used: Bᵢⱼ∈ [symbol] where Bᵢⱼ=Aᵢⱼe^{jθ}^{ᵢ}.

$${M}_{j} = {\sum }_{i} {B}_{ij} \begin{matrix}\vert {I}_{i} \vert & ∀ j\end{matrix} \qquad ( 5 )$$

This may be solved by taking the pseudo-inverse of |Iᵢ| and multiplying it by Mⱼ:

$${B}_{j} = \begin{matrix}{\vert I \vert}^{†} {M}_{j} & ∀ j\end{matrix} \qquad ( 6 )$$

Then, the matrix Aᵢⱼ may be recovered, where Aᵢⱼ=|Bᵢⱼ| and θᵢ=∠Bᵢⱼ.

It should be noted that this solution relies on the assumption that the phase angle of each piece of equipment (e.g., EVSE) is constant over time. This may not be true in some cases. Here, Bᵢⱼ is a complex number. Thus, Aᵢⱼ may be obtained by taking a magnitude of the complex number. Moreover, the phase information may be obtained, too, from the phase angle of the complex number. For example, the identified phase information may be exact, when the phase angle at the line level is available.

In some aspects, only the magnitude of the current phasors of each piece of equipment and each line may be available. For example, the unknown phase angles may not be included in the matrix Bᵢⱼ since the phase angle of each line may not be constant over time. When loads are connected line-to-line, these line current phase angles may vary (e.g., widely) over time due to unbalance. Instead, a heuristic method may be used. When the current draw of a piece of equipment increases, the current in the lines that this piece of equipment is connected to will also increase. Likewise, the currents in the lines that this piece of equipment is not connected to should be unaffected. While these mappings may be non-linear, the approximate correlations between the current draw of each piece of equipment and the current draw of each line may be recovered based on at least some amount of data.

Here, the following matrix Cᵢⱼ∈ [symbol] may be used, such that:

$$\vert {M}_{j} \vert = {\sum }_{i} {C}_{ij} \begin{matrix}\vert {I}_{i} \vert + ϵ & ∀ j\end{matrix} \qquad ( 7 )$$

This may be solved by taking the pseudo-inverse of |I| and multiplying it by Mⱼ to find C which minimizes ∈:

$$\begin{matrix}{C}_{j} = \begin{matrix}{\vert I \vert}^{†} \vert {M}_{j} \vert & ∀\end{matrix} j \\ or\end{matrix} \qquad ( 8 )$$

$$C = {\vert I \vert}^{†} \vert M \vert \qquad ( 9 )$$

Once C is obtained, it can be used to recover A.

As an example, the case of a single layer network may be considered. For example, a network may have three lines. Let Aᵢ be the row of the adjacency matrix corresponding to device i. Aᵢ may describe how device i is connected to the network. There are 8 possibilities. See Table 1, below.

TABLE 1

| Phase | Aᵢ | \|Aᵢ\| |
|---|---|---|
| A | [1, 0, 0] | [1, 0, 0] |
| B | [0, 1, 0] | [0, 0, 1] |
| C | [0, 0, 1] | [0, 0, 1] |
| AB | [1, −1, 0] | [1, 1, 0] |
| BC | [0, 1, −1] | [0, 1, 1] |
| CA | [−1, 0, 1] | [1, 0, 1] |
| ABC | [1, 1, 1] | [1, 1, 1] |
| Disconnect | [0, 0, 0] | [0, 0, 0] |

While some of the entries in Aᵢ are negative, the magnitude of the current will still increase when the piece of equipment is connected to that line due to differences in phase angles.

Cᵢ may be converted to Aᵢ as follows.

(1) If Cᵢ≈[0,0,0], then Aⱼ=[0,0,0] and the piece of equipment is not connected to the metered subsystem.

(2) If Cᵢⱼ>τ, replace Cᵢⱼ with 1, otherwise replace it with 0.

(3) Match the resulting vector to the closest vector in the |Aⱼ| column of the table above to get the phase and Aⱼ for the equipment.

As described herein, the adjacency matrix may be solved for, where every value of the matrix is 1, 0, or −1, indicating current receiving line, no connection to line, and current outgoing line. The adjacency matrix may be solved for each individual node (e.g., an electrical panel or an electrical subpanel), or for multiple (e.g., all) nodes. Each column of the adjacency matrix corresponds to a line on an electrical panel or an electrical subpanel, and each row corresponds to a piece of equipment. For example, a three-column group may correspond to a particular electrical panel or subpanel, where the adjacency may be solved for multiple nodes.

For example, Cᵢⱼ may be a representation of Aᵢⱼ, without the phase information, and may be converted into Aᵢⱼ based on the heuristic method described herein. For example, with phase information, this may be a linear relationship. Without the phase information, the relationship between two magnitudes may be non-linear (e.g., where an estimation may be done to treat each value as, for example, 1 or 0 based on proximity to a defined threshold). Such threshold may be determined empirically.

To extend this method, described above, to multi-layer networks, each node may be considered separately. It is not necessary to know which piece of equipment is connected to a node a priori since the piece of equipment that is not connected to this node will result in Aᵢ=[0, 0, 0] (disconnected).

Using the methods described above, certain aspects of the present disclosure may provide a system to identify the phase angle of current of each piece of equipment using measured data. For example, these methods may be incorporated into an automated system. In some aspects, an example system may include the following components: a metering system, one or more pieces of equipment, a data acquisition system, and one or more processors.

Referring to FIG. 6, an example 600 of an EVSE network (e.g., a single-layer network, with no electrical subpanel), including a system for determining a topology of an EVSE network (e.g., by identifying the phase of each piece of equipment), is depicted. Since each piece of equipment is connected to an electrical panel in a single-layer network, the phase angle of current of each piece of equipment may be identified to determine the topology of such EVSE network. The example 600 includes a connection to utility grid 114d, an electrical panel (e.g., a main switchboard) 602, a meter 604 (which may be a metering system or a portion of a metering system), a data acquisition component 606, a processor 608, and a plurality of pieces of equipment 610a, 610b, 610c (illustrated as, respectively, “LOAD 1”, “LOAD 2”, and “LOAD 3”, which may be collectively referred to as pieces of equipment 610). While three pieces of equipment are shown, the number of the pieces of equipment can vary. One or more of the pieces of equipment 610 may be an EVSE or a DER. As depicted, the electrical panel 602 may be connected to the utility grid 114d as well as the meter 604 and the pieces of equipment 610. In some aspects, these components of the example 600 may be software or hardware components, and the functionality described herein may be combined or separated into any suitable number of components. For example, one or more of the components may be software stored in memory and executing on one or more processors.

In certain aspects, the data acquisition component 606 may be connected to and obtain data (e.g., measurement of magnitude of current phasor) from the meter 604 and the pieces of equipment 610 (e.g., by respective meters on the pieces of equipment 610). The meter 604 may provide data as measured for the electrical panel 602. The data acquisition component 606 may provide the obtained data to the processor 608. The processor 608 may use the obtained data to perform the methods described above to determine a topology of the EVSE network depicted in FIG. 6, for example, by identifying the phase angle of current of each piece of equipment as described above.

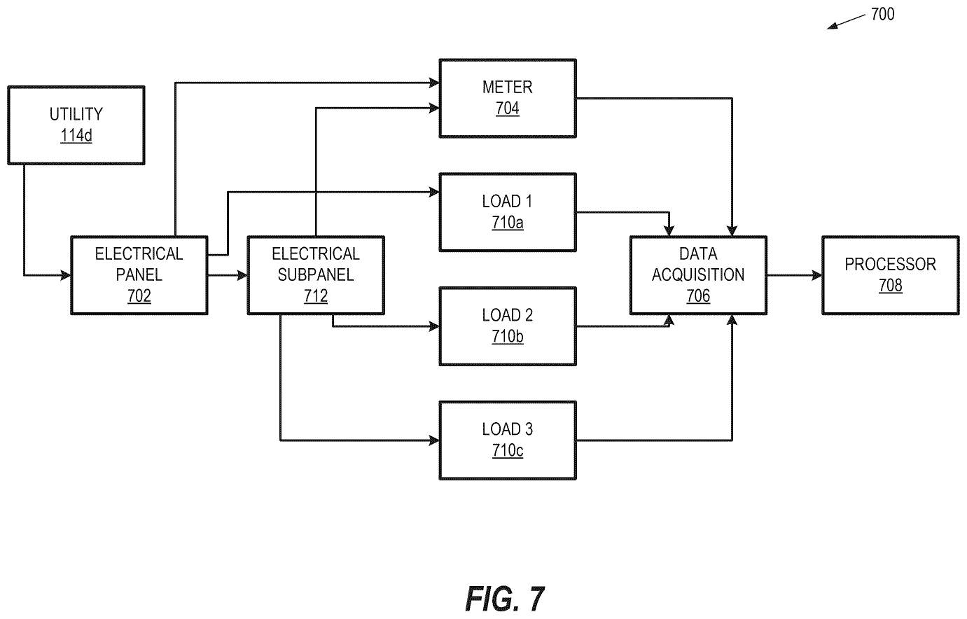

FIG. 7 depicts an example 700 of an EVSE network (e.g., a multi-layer network, with at least one electrical subpanel), including a system for determining a topology of an EVSE network (e.g., by identifying the phase angle of current of each piece of equipment). Since an electrical panel and an electrical subpanel may have different limits, information regarding to which electrical panel or electrical subpanel each piece of equipment is connected may be identified to determine the topology of such EVSE network. The example 700 includes a connection to utility grid 114d, an electrical panel (e.g., a main switchboard) 702, a meter 704 (which may be a metering system or a portion of a metering system), a data acquisition component 706, a processor 708, a plurality of pieces of equipment 710a, 710b, 710c (illustrated as, respectively, “LOAD 1”, “LOAD 2”, and “LOAD 3”, which may be collectively referred to as pieces of equipment 710), and an electrical subpanel (e.g., a load center) 712. While three pieces of equipment are shown, the number of the pieces of equipment can vary. As depicted, the electrical panel 702 may be connected to the utility grid 114d as well as the meter 704, the first piece of equipment 710a, and the electrical subpanel 712. Moreover, the electrical subpanel 712 may be connected to the meter 704 as well as the second piece of equipment 710b and the third piece of equipment 710c. One or more of the pieces of equipment 710 may each be an EVSE or a DER. In some aspects, these components of the example 700 may be software or hardware components, and the functionality described herein may be combined or separated into any suitable number of components. For example, one or more of the components may be software stored in memory and executing on one or more processors.

In certain aspects, the data acquisition component 706 may be connected to and obtain data (e.g., measurement of magnitude of current phasor) from the meter 704 and the pieces of equipment 710 (e.g., by respective meters on the pieces of equipment 710). The meter 704 may provide data as measured for the electrical panel 702 and for the electrical subpanel 712. The data acquisition component 706 may provide the obtained data to the processor 708. The processor 708 may use the obtained data to perform the methods described above to determine a topology of the EVSE network depicted in FIG. 7, for example, by identifying the phase angle of current of each piece of equipment as described above.

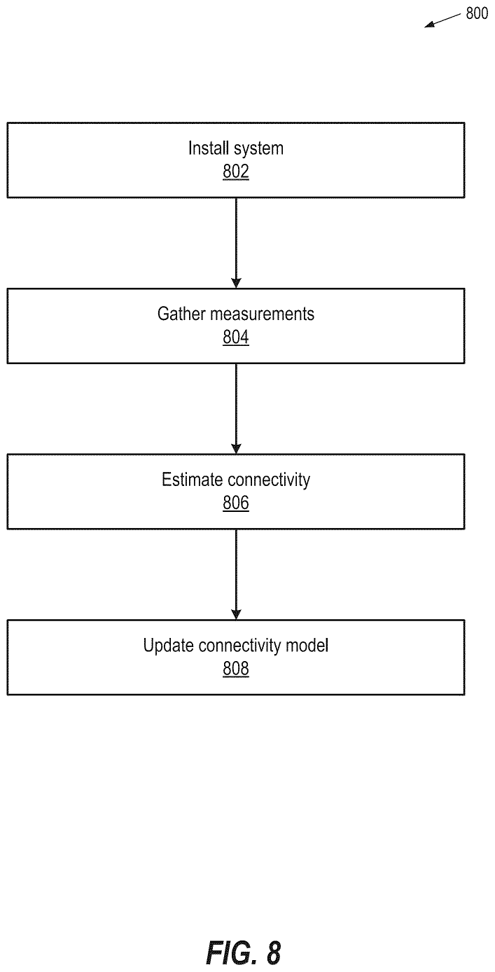

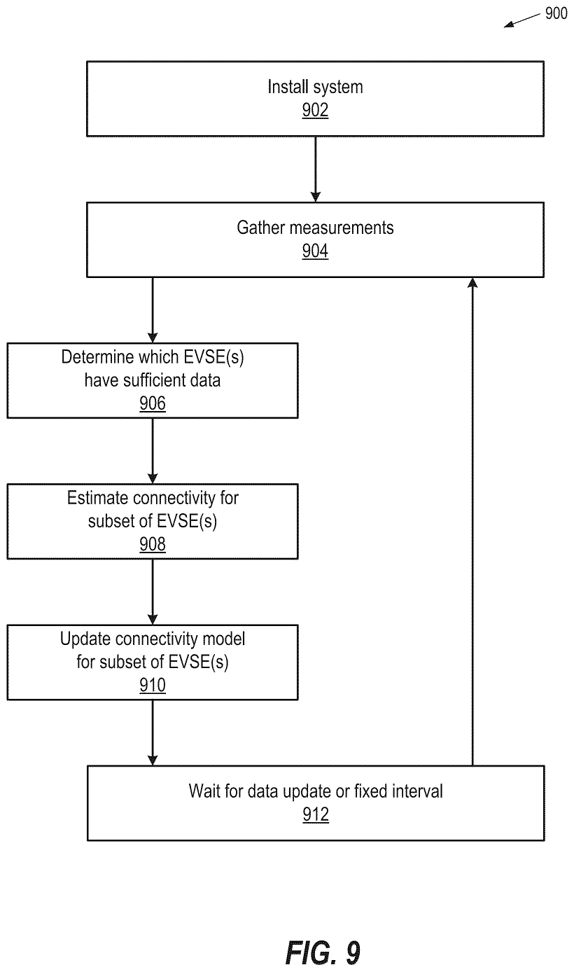

FIGS. 8 and 9 illustrate example methods for using the estimation methods and systems described herein. Each of these methods can be used with any of the estimation methods and system configurations described herein.

FIG. 8 depicts an example process flow 800 for determining a topology of an EVSE network. In certain aspects, the process flow 800 may be performed, at least in part, by a topology detection system, such as implemented by at least the topology detection component 236 of FIG. 2 and/or the topology detection component 540 of FIG. 5. In certain aspects, the process flow 800 illustrates a “one shot approach”. In the one shot approach, an EVSE network system may be installed (at 802) and operated in a conservative manner until a sufficient amount of data is obtained to estimate the connectivity of the EVSE network.

At 804, the sufficient amount of data may be obtained or gathered (e.g., from one or more meters, such as meter 604 of FIG. 6 or meter 704 of FIG. 7) to estimate the connectivity of the EVSE network.

At 806, once the sufficient amount of data has been obtained to estimate the connectivity of the EVSE network, the estimation methods described herein may be performed to estimate the connectivity of the EVSE network.

At 808, a connectivity model may be updated based on the estimation methods performed, at which point a site may be considered commissioned.

FIG. 9 depicts an example process flow 900 for determining a topology of an EVSE network. In certain aspects, the process flow 900 may be performed, at least in part, by a topology detection system, such as implemented by at least the topology detection component 236 of FIG. 2 and/or the topology detection component 540 of FIG. 5. In certain aspects, a connectivity of the EVSE network may be estimated in an iterative manner. For example, in order to estimate the connectivity of an entire EVSE network, data or measurements corresponding to each piece of equipment (e.g., EVSE or DER) being used in the EVSE network may be utilized. In some cases, not all EVSEs may be in use (e.g., where one or more EVSEs may be broken or rarely used). In such a case, an iterative approach may be used, where the connectivity for a subset of pieces of equipment (e.g., EVSEs) may calculated. This process may be repeated as new data is made available or at a fixed (e.g., defined) cadence.

At 902, an EVSE network system may be installed.

At 904, data or measurements may be obtained or gathered (e.g., from one or more meters, such as meter 604 of FIG. 6 or meter 704 of FIG. 7).

At 906, the topology detection system may determine which EVSE(s) (e.g., a subset of EVSEs) have sufficient data.

At 908, connectivity may be estimated for the subset of EVSEs that are determined to have sufficient data (from 906).

At 910, a connectivity model may be updated for the subset of EVSEs.

At 912, the topology detection system may wait for data update (e.g., from additional pieces of equipment such as EVSEs or DERs) or for a fixed (e.g., defined) interval of time.

Then, steps 904, 906, 908, 910, and 912 may repeat iteratively. In certain aspects, the process flow 900 may be stopped once the connectivity of all equipment is determined. In some aspects, the process flow 900 may not be stopped even after the connectivity of all equipment is determined.

In some aspects, the data or measurements from each piece of equipment in an EVSE network may be obtained naturally (e.g., without intentionally gathering the data, but based on a normal or natural usage of the EVSE network). In some aspects, the obtaining or gathering of the data or measurements may be accelerated, as described below.

In certain aspects, the obtaining or gathering of the data or measurements may be accelerated by signal injection. In some cases, the normal usage of the EVSE network may provide sufficient variations such that rank(I)=N and such that there may be a unique solution to the connectivity estimation problem. In some cases, it may take time (e.g., depending on system usage) to collect enough linearly independent measurements such that rank(I)=N. Thus, the operations of the system may be managed to force linearly independent measurements. This may be referred to as signal injection. In some aspects, a (e.g., ideal) signal injection may be to have one EVSE active at a time. This may be helpful for the heuristic method described above, since this removes spurious correlations.

In certain aspects, one way to perform a signal injection may be to have a technician manually plug in a vehicle to each EVSE, one at time. This way has the benefit of assuring that only one EVSE is active at a time, making it very easy to estimate connectivity. This method allows connectivity to be estimated as soon as the chargers are installed. It can also be combined with post-commissioning health check of each charger. In some aspects, to reduce this manual labor, a control system may be used to automatically adjust charging rates to improve the usefulness of the measurements by increasing rank(I). For example, the signal injection process may be automated by modulating the charging rate of one EVSE while holding the charging rate of each of other EVSEs constant. This process may be repeated for each EVSE. Another option to reduce linear dependence in measurements may be to inject randomness in the charging rate assigned to each EVSE. Both of these approaches may provide better quality data for estimating connectivity.

In some aspects, a certain level (e.g., magnitude) of current draw that is differentiated from other signals of current draw may enable the signal injection. In certain aspects, multiple signal injections may be performed simultaneously (e.g., for an automatic signal injection) by using different set points, such as at different levels of current draw). In some aspects, random noises may be introduced for variability in the signals of current draw, such as for a given time period.

In certain aspects, some meters may provide the current phasor (e.g., directly). For those that do not, the line current phase angle may be estimated by using the power factor and voltage phase angle.

$$∠ {M}_{j} ( t ) = {cos}^{- 1} ( {pf}_{j} ( t ) ) + ∠ {V}_{j} ( t ) \qquad ( 10 )$$

If the voltage phase angle is also not available, the voltage phase angles may be assumed to be balanced in some cases, and their nominal values may be used.

As described herein, information regarding which equipment is connected to, for example which electrical subpanel, what phase angle of current each piece of equipment is connected to, etc. may be useful for performing load management accurately and for avoiding overloading any portion of an EVSE network. In some aspects, the methods described herein for determining a topology of an EVSE network may be detected once (e.g., at a given time such as when the EVSE network is being commissioned) or periodically (such that the EVSE network may adapt to any change in topology). For example, when an EVSE is replaced, certain aspects described herein may determine the logical location within the EVSE network where such EVSE is replaced.

In certain aspects, a load management system of an EVSE network (e.g., which is implemented by one or more components of the edge environment 102 and/or one or more components of the cloud environment 104) may obtain and utilize the connectivity information of the EVSE network to determine the topology of the EVSE network. For example, when a topology of an EVSE network is estimated incrementally (e.g., iteratively), the systems and methods described in U.S. patent application Ser. No. 18/789,880, entitled “SYSTEMS AND METHODS FOR CHARGING A PLURALITY OF ELECTRIC ASSETS” and filed Jul. 31, 2024, which is hereby incorporated by reference in its entirety, may be used to operate a portion of the EVSE network where topology has not been estimated. For example, the EVSE network may be operated conservatively, where the operating may be done below any limit or constraint associated with the unknown portion of the EVSE network (e.g., by a “cushion” or a defined level of charging rate or throughput below the charging rate or throughput at such limit or constraint). In some cases, the EVSE network may be operated conservatively (e.g., reverting to operation below the limit or constraint discussed above) when there is a change (e.g., which may otherwise be previously unknown). Moreover, the load management for a portion of the EVSE network where topology has not been estimated may be combined with the load management for a portion of the EVSE network where topology has been estimated. For a portion of the EVSE network where topology has already been estimated, such portion of the EVSE network may be operated based on the systems and methods described in U.S. patent application Ser. No. 17/821,972, entitled “ELECTRIC VEHICLE CHARGING FACILITY MULTI-ASSET OPTIMIZATION” and filed Aug. 24, 2022 and U.S. Pat. No. 10,926,659, entitled “OPTIMIZATION FRAMEWORK AND METHODS FOR ADAPTIVE EV CHARGING” and issued Feb. 23, 2021, each of which is hereby incorporated by reference in its entirety.

An increase in the portion of an EVSE network where topology is known or estimated enable the load management to be more efficient (e.g., where the EVSE network is operating closer to the limits at various nodes of the EVSE network), allowing higher charging throughput through the EVSE network. For example, the level of current flow through a line in the EVSE network may be closer to the associated limit for the line, such that, for example, more vehicles may be charged more quickly. As another example, a current limit may be increased for a piece of equipment based on determining the topology of the EVSE network (e.g., relating to a subset of lines of the EVSE network to which the piece of equipment is coupled, etc.). In certain aspects, one or more parameters or set-points associated with such a piece of equipment may be adjusted (e.g., increased) by the methods or systems described herein, such as to operate closer to the associated limit for a connected line. As discussed above, such an adjustment to the parameter(s) or set-point(s) may accordingly result in increased charging throughput through the EVSE network.

In certain aspects, a determined topology of an EVSE network may be used to operate the EVSE network (e.g., to perform a load management based on the determined topology of the EVSE network). The determined topology may indicate various electrical components within the EVSE network. For example, the determined topology may indicate active electrical components and passive electrical components within the EVSE network. The active electrical components may include any component which produces or consumes electric power. The passive electrical components may include elements like lines, breakers, panels, and transformers that pass electric current and power. Such elements may or may not have limits on the current or power that passes through them. The determined topology may also indicate how the active electrical components and the passive electrical components are connected to each other. For example, the determined topology may indicate the passive electrical components that connect the active electrical components to one other.

In certain aspects, a component (e.g., a controller) may generate a graph based on the determined topology of the EVSE network. The graph may include nodes representing the active electrical components and the passive electrical components in the determined topology. The nodes may be connected by edges that correspond to the connections between the active electrical components and the passive electrical components. As a result, the graph may represent the electrical components within the EVSE network and the connections between these electrical components in the EVSE network.

In some aspects, the controller (or another component or logic) may determine how to adjust electric current or power draw within the EVSE network to achieve one or more objectives (e.g., optimization or load management objectives). In certain aspects, the controller may map each node of the graph described above to a corresponding electric current or power draw. The controller may use an optimization process that analyzes the graph to determine a strategy for adjusting the electric current or power draw of one or more components in the EVSE network to achieve the objective(s). The controller may output the results of this process to, for example, a switchboard which gathers electrical information from other components of the EVSE network and generates and dispatches set points (e.g., levels of electric current or power draw) to the other components. The controller may, by the output results of the optimization process, inform the switchboard how to adjust the electric current or power draw in the EVSE network.

### Example Method of Determining a Topology of an EVSE Network

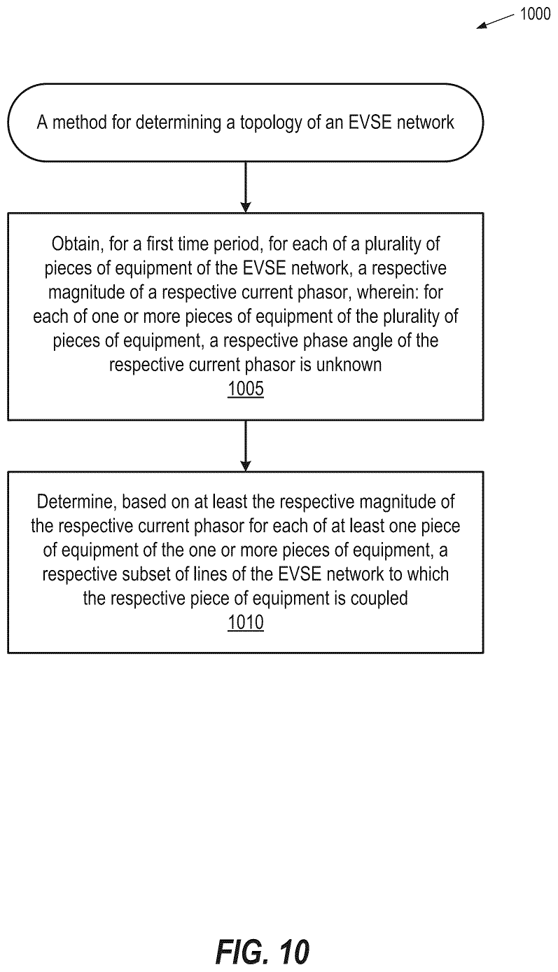

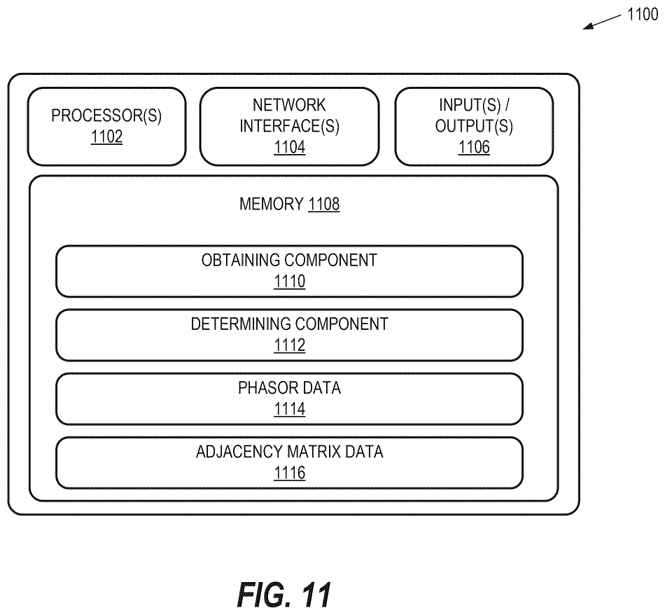

FIG. 10 depicts an example flowchart illustrating a method 1000 for determining a topology of an EVSE network, according to aspects provided herein. The method 1000 may be performed by a core device 302 of FIGS. 3A-3C, for example, by utilizing one or more components of edge environment 102 described herein with respect to FIG. 2 and/or one or more components of cloud environment 104 described herein with respect to FIG. 5. In some aspects, the method 1000 may be performed by an apparatus or a processing system, for example, by utilizing one or more components of processing system 1100 described herein with respect to FIG. 11.

Method 1000 begins at block 1005 with obtaining, for a first time period, for each of a plurality of pieces of equipment of the EVSE network, a respective magnitude of a respective current phasor, wherein: for each of one or more pieces of equipment of the plurality of pieces of equipment, a respective phase angle of the respective current phasor is unknown, such as described with respect to FIG. 6, 7, 8, or 9.

Method 1000 then proceeds to block 1010 with determining, based on at least the respective magnitude of the respective current phasor for each of at least one piece of equipment of the one or more pieces of equipment, a respective subset of lines of the EVSE network to which the respective piece of equipment is coupled, such as described with respect to FIG. 6, 7, 8, or 9.

In some aspects, determining the respective subset of lines of the EVSE network to which the respective piece of equipment is coupled comprises determining one or more of: an electrical panel to which the respective piece of equipment is coupled, or the respective phase angle of the respective current phasor of the respective piece of equipment.

In some aspects, the method 1000 further comprises performing a signal injection to accelerate determining the respective subset of lines of the EVSE network to which the respective piece of equipment is coupled, wherein performing the signal injection comprises modulating a charging rate of an EVSE while holding a charging rate of each of other EVSEs constant.

In some aspects, the method 1000 further comprises performing a signal injection to accelerate determining the respective subset of lines of the EVSE network to which the respective piece of equipment is coupled, wherein performing the signal injection comprises randomizing a charging rate of each of a plurality of EVSEs of the EVSE network.

In some aspects, obtaining, for a second time period, for each of the plurality of pieces of equipment of the EVSE network, a respective magnitude of a respective second current phasor, wherein: for each of the one or more pieces of equipment of the plurality of pieces of equipment, a respective phase angle of the respective second current phasor is unknown; determining, based on at least the respective magnitude of the respective second current phasor for each of the at least one piece of equipment of the one or more pieces of equipment, a respective second subset of lines of the EVSE network to which the respective piece of equipment is coupled; and detecting, based on a comparison of the respective subset of lines of the EVSE network and the respective second subset of lines of the EVSE network, a change in the topology of the EVSE network.

In some aspects, the method 1000 further comprises modifying a current limit of a first piece of equipment of the at least one piece of equipment based on the detected change in the topology of the EVSE network.

In some aspects, the plurality of pieces of equipment comprise: a plurality of EVSEs; a plurality of lines; and one or more electrical panels.

In some aspects, the plurality of pieces of equipment further comprise one or more distributed energy resources (DERs).

In some aspects, the one or more pieces of equipment comprise one or more EVSEs of the plurality of EVSEs.

In some aspects, the one or more pieces of equipment comprise the plurality of pieces of equipment.

In some aspects, the one or more pieces of equipment comprise a subset of the plurality of pieces of equipment.

In some aspects, block 1010 comprises: determining an adjacency matrix, wherein each row of the adjacency matrix corresponds to a respective piece of equipment of the plurality of pieces of equipment, and each column of the adjacency matrix corresponds to a respective line of the EVSE network.

In some aspects, the method 1000 further comprises: increasing a current limit of a first piece of equipment of the at least one piece of equipment based on the determined respective subset of lines of the EVSE network to which the respective piece of equipment is coupled.

In some aspects, the method 1000 enables several technical benefits and advances the state of the art in determining a topology of an EVSE network and controlling the EVSE network accordingly. For example, certain aspects of the method 1000 may enable an automatic determination of a topology of an EVSE network based on data collected by one or more meters, which may reduce the time needed to commission a site and may reduce an amount of error associated with determining the topology of the EVSE network, as well as other technically beneficial advantages that are described herein.

In some aspects, the method 1000 may be performed by an apparatus or a processing system, for example, by utilizing one or more components of processing system 1100 described herein with respect to FIG. 11.

### Example Processing System for Determining a Topology of an EVSE Network

FIG. 11 depicts an example processing system 1100 configured to perform the methods described herein.

Processing system 1100 may include one or more processors 1102. Generally, the one or more processors 1102 may be configured to execute computer-executable instructions (e.g., software code) to perform various functions, as described herein.

Processing system 1100 may further include one or more network interfaces 1104, which generally provide data access to any sort of data network, including personal area networks (PANs), local area networks (LANs), wide area networks (WANs), the internet, and the like.

Moreover, processing system 1100 may include input(s) and output(s) 1106, which generally provide means for providing data to and from processing system 1100, such as via connection to computing device peripherals, including user interface peripherals.

Processing system 1100 may also include one or more memories 1108 comprising various components. In this example, the one or more memories 1108 may include obtaining component 1110 and determining component 1112.

In certain aspects, obtaining component 1110 is configured to obtain, for a first time period, for each of a plurality of pieces of equipment of the EVSE network, a respective magnitude of a respective current phasor (e.g., phasor data 1114), wherein: for each of one or more pieces of equipment of the plurality of pieces of equipment, a respective phase angle of the respective current phasor is unknown, as described in FIG. 10 with reference to block 1005. In certain aspects, determining component 1112 is configured to determine, based on at least the respective magnitude of the respective current phasor for each of at least one piece of equipment of the one or more pieces of equipment, a respective subset of lines of the EVSE network to which the respective piece of equipment is coupled, as described in FIG. 10 with reference to block 1010. In some aspects, determining the respective subset of lines of the EVSE network to which the respective piece of equipment is coupled includes determining an adjacency matrix (e.g., adjacency matrix data 1116), where each row of the adjacency matrix corresponds to a respective piece of equipment of the plurality of pieces of equipment, and each column of the adjacency matrix corresponds to a respective line of the EVSE network.

Processing system 1100 may be implemented in various ways. For example, processing system 1100 may be implemented as a computing device 402 within a core device 302, described herein with respect to FIGS. 3A-3C and 4A. In various aspects, one or more aspects may be omitted from, added to, or substituted from processing system 1100.

### Example Clauses

Implementation examples are described in the following numbered clauses:
Clause 1: A method for determining a topology of an EVSE network, the method comprising: obtaining, for a first time period, for each of a plurality of pieces of equipment of the EVSE network, a respective magnitude of a respective current phasor, wherein: for each of one or more pieces of equipment of the plurality of pieces of equipment, a respective phase angle of the respective current phasor is unknown; and determining, based on at least the respective magnitude of the respective current phasor for each of at least one piece of equipment of the one or more pieces of equipment, a respective subset of lines of the EVSE network to which the respective piece of equipment is coupled.
Clause 2: The method in accordance with Clause 1, wherein determining the respective subset of lines of the EVSE network to which the respective piece of equipment is coupled comprises determining one or more of: an electrical panel to which the respective piece of equipment is coupled, or the respective phase angle of the respective current phasor of the respective piece of equipment.
Clause 3: The method in accordance with any one of Clauses 1-2, further comprising: performing a signal injection to accelerate determining the respective subset of lines of the EVSE network to which the respective piece of equipment is coupled, wherein performing the signal injection comprises modulating a charging rate of an EVSE while holding a charging rate of each of other EVSEs constant.
Clause 4: The method in accordance with any one of Clauses 1-3, further comprising: performing a signal injection to accelerate determining the respective subset of lines of the EVSE network to which the respective piece of equipment is coupled, wherein performing the signal injection comprises randomizing a charging rate of each of a plurality of EVSEs of the EVSE network.
Clause 5: The method in accordance with any one of Clauses 1-4, further comprising: obtaining, for a second time period, for each of the plurality of pieces of equipment of the EVSE network, a respective magnitude of a respective second current phasor, wherein: for each of the one or more pieces of equipment of the plurality of pieces of equipment, a respective phase angle of the respective second current phasor is unknown; determining, based on at least the respective magnitude of the respective second current phasor for each of the at least one piece of equipment of the one or more pieces of equipment, a respective second subset of lines of the EVSE network to which the respective piece of equipment is coupled; and detecting, based on a comparison of the respective subset of lines of the EVSE network and the respective second subset of lines of the EVSE network, a change in the topology of the EVSE network.
Clause 6: The method in accordance with Clause 5, further comprising: modifying a current limit of a first piece of equipment of the at least one piece of equipment based on the detected change in the topology of the EVSE network.
Clause 7: The method in accordance with any one of Clauses 1-6, wherein the plurality of pieces of equipment comprise: a plurality of EVSEs; a plurality of lines; and one or more electrical panels.
Clause 8: The method in accordance with Clause 7, wherein the plurality of pieces of equipment further comprise one or more distributed energy resources (DERs).
Clause 9: The method in accordance with Clause 7, wherein the one or more pieces of equipment comprise one or more EVSEs of the plurality of EVSEs.
Clause 10: The method in accordance with any one of Clauses 1-9, wherein the one or more pieces of equipment comprise the plurality of pieces of equipment.
Clause 11: The method in accordance with any one of Clauses 1-10, wherein the one or more pieces of equipment comprise a subset of the plurality of pieces of equipment.
Clause 12: The method in accordance with any one of Clauses 1-11, wherein determining the respective subset of lines of the EVSE network to which the respective piece of equipment is coupled comprises: determining an adjacency matrix, wherein each row of the adjacency matrix corresponds to a respective piece of equipment of the plurality of pieces of equipment, and each column of the adjacency matrix corresponds to a respective line of the EVSE network.
Clause 13: The method in accordance with any one of Clauses 1-12, further comprising: increasing a current limit of a first piece of equipment of the at least one piece of equipment based on the determined respective subset of lines of the EVSE network to which the respective piece of equipment is coupled.
Clause 14: One or more apparatuses, comprising means for performing a method in accordance with any one of Clauses 1-13.
Clause 15: A processing system, comprising means for performing a method in accordance with any one of Clauses 1-13.
Clause 16: A processing system, comprising: one or more memories comprising computer-executable instructions; and one or more processors configured to execute the computer-executable instructions and cause the processing system to perform a method in accordance with any one of Clauses 1-13.
Clause 17: A non-transitory computer-readable medium comprising computer-executable instructions that, when executed by a processor of a processing system, cause the processing system to perform a method in accordance with any one of Clauses 1-13.
Clause 18: A computer program product embodied on a computer-readable storage medium comprising code for performing a method in accordance with any one of Clauses 1-13.
Clause 19: A processing system, comprising: one or more memories; and one or more processors, coupled to the one or more memories, configured to cause the processing system to perform a method in accordance with any one of clauses 1-13.

### ADDITIONAL CONSIDERATIONS

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the generic principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

As used herein, the word “exemplary” means “serving as an example, instance, or illustration.” Any aspect described herein as “exemplary” is not necessarily to be construed as preferred or advantageous over other aspects.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims. Further, the various operations of methods described above may be performed by any suitable means capable of performing the corresponding functions. The means may include various hardware and/or software component(s) (logic) and/or module(s), including, but not limited to a circuit, an application specific integrated circuit (ASIC), or processor. Generally, where there are operations illustrated in figures, those operations may have corresponding counterpart means-plus-function components with similar numbering.

The following claims are not intended to be limited to the aspects shown herein, but are to be accorded the full scope consistent with the language of the claims. Reference to an element in the singular is not intended to mean only one unless specifically so stated, but rather “one or more.” The subsequent use of a definite article (e.g., “the” or “said”) with an element (e.g., “the processor”) is not intended to invoke a singular meaning (e.g., “only one”) on the element unless otherwise specifically stated. For example, reference to an element (e.g., “a processor,” “a memory,” “the processor,” “the memory,” etc.), unless otherwise specifically stated, should be understood to refer to one or more elements (e.g., “one or more processors,” “one or more memories,” etc.). The terms “set” and “group” are intended to include one or more elements, and may be used interchangeably with “one or more.” Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., a system) to perform functions, one element may be configured to cause the other element to perform all functions, or more than one element may collectively be configured to cause the other element to perform the functions. Unless specifically stated otherwise, the term “some” refers to one or more. No claim element is to be construed under the provisions of 35 U.S.C. § 112 (f) unless the element is expressly recited using the phrase “means for” or, in the case of a method claim, the element is recited using the phrase “step for.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

While particular aspects and aspects of the present disclosure have been illustrated and described herein, various other changes and modifications can be made without departing from the spirit and scope of the disclosure. Moreover, although various aspects have been described herein, such aspects need not be utilized in combination. Accordingly, it is therefore intended that the appended claims cover all such changes and modifications that are within the scope of the aspects shown and described herein.

What is claimed is:

1. A method for determining a topology of an electric vehicle supply equipment (EVSE) network, the method comprising:
obtaining, for a first time period, for each of a plurality of pieces of equipment of the EVSE network, a respective magnitude of a respective current phasor, wherein:
for each of one or more pieces of equipment of the plurality of pieces of equipment, a respective phase angle of the respective current phasor is unknown; and
determining, based on at least the respective magnitude of the respective current phasor for each of at least one piece of equipment of the one or more pieces of equipment, a respective subset of lines of the EVSE network to which the respective piece of equipment is coupled.

2. The method of claim 1, wherein determining the respective subset of lines of the EVSE network to which the respective piece of equipment is coupled comprises determining one or more of:
an electrical panel to which the respective piece of equipment is coupled, or
the respective phase angle of the respective current phasor of the respective piece of equipment.

3. The method of claim 1, further comprising:
performing a signal injection to accelerate determining the respective subset of lines of the EVSE network to which the respective piece of equipment is coupled,
wherein performing the signal injection comprises modulating a charging rate of an EVSE while holding a charging rate of each of other EVSEs constant.

4. The method of claim 1, further comprising:
performing a signal injection to accelerate determining the respective subset of lines of the EVSE network to which the respective piece of equipment is coupled,
wherein performing the signal injection comprises randomizing a charging rate of each of a plurality of EVSEs of the EVSE network.

5. The method of claim 1, further comprising:
obtaining, for a second time period, for each of the plurality of pieces of equipment of the EVSE network, a respective magnitude of a respective second current phasor, wherein:
for each of the one or more pieces of equipment of the plurality of pieces of equipment, a respective phase angle of the respective second current phasor is unknown;
determining, based on at least the respective magnitude of the respective second current phasor for each of the at least one piece of equipment of the one or more pieces of equipment, a respective second subset of lines of the EVSE network to which the respective piece of equipment is coupled; and
detecting, based on a comparison of the respective subset of lines of the EVSE network and the respective second subset of lines of the EVSE network, a change in the topology of the EVSE network.

6. The method of claim 5, further comprising:
modifying a current limit of a first piece of equipment of the at least one piece of equipment based on the detected change in the topology of the EVSE network.

7. The method of claim 1, wherein the plurality of pieces of equipment comprise:
a plurality of EVSEs;
a plurality of lines; and
one or more electrical panels.

8. The method of claim 7, wherein the plurality of pieces of equipment further comprise one or more distributed energy resources (DERs).

9. The method of claim 7, wherein the one or more pieces of equipment comprise one or more EVSEs of the plurality of EVSEs.

10. The method of claim 1, wherein the one or more pieces of equipment comprise the plurality of pieces of equipment.

11. The method of claim 1, wherein the one or more pieces of equipment comprise a subset of the plurality of pieces of equipment.

12. The method of claim 1, wherein determining the respective subset of lines of the EVSE network to which the respective piece of equipment is coupled comprises:
determining an adjacency matrix, wherein each row of the adjacency matrix corresponds to a respective piece of equipment of the plurality of pieces of equipment, and each column of the adjacency matrix corresponds to a respective line of the EVSE network.

13. The method of claim 1, further comprising:
increasing a current limit of a first piece of equipment of the at least one piece of equipment based on the determined respective subset of lines of the EVSE network to which the respective piece of equipment is coupled.

14. A processing system, comprising: one or more memories; and one or more processors, coupled to the one or more memories, configured to cause the processing system to:
obtain, for a first time period, for each of a plurality of pieces of equipment of an electric vehicle supply equipment (EVSE) network, a respective magnitude of a respective current phasor, wherein:
for each of one or more pieces of equipment of the plurality of pieces of equipment, a respective phase angle of the respective current phasor is unknown; and
determine, based on at least the respective magnitude of the respective current phasor for each of at least one piece of equipment of the one or more pieces of equipment, a respective subset of lines of the EVSE network to which the respective piece of equipment is coupled.

15. The processing system of claim 14, wherein to cause the processing system to determine the respective subset of lines of the EVSE network to which the respective piece of equipment is coupled, the one or more processors are configured to cause the processing system to determine one or more of:
an electrical panel to which the respective piece of equipment is coupled, or
the respective phase angle of the respective current phasor of the respective piece of equipment.

16. The processing system of claim 14, wherein the one or more processors are further configured to cause the processing system to:
perform a signal injection to accelerate determining the respective subset of lines of the EVSE network to which the respective piece of equipment is coupled,
wherein to cause the processing system to perform the signal injection, the one or more processors are configured to cause the processing system to modulate a charging rate of an EVSE while holding a charging rate of each of other EVSEs constant.

17. The processing system of claim 14, wherein the one or more processors are further configured to cause the processing system to:
perform a signal injection to accelerate determining the respective subset of lines of the EVSE network to which the respective piece of equipment is coupled,
wherein to cause the processing system to perform the signal injection, the one or more processors are configured to cause the processing system to randomize a charging rate of each of a plurality of EVSEs of the EVSE network.

18. The processing system of claim 14, wherein the one or more processors are further configured to cause the processing system to:
obtain, for a second time period, for each of the plurality of pieces of equipment of the EVSE network, a respective magnitude of a respective second current phasor, wherein:
for each of the one or more pieces of equipment of the plurality of pieces of equipment, a respective phase angle of the respective second current phasor is unknown;
determine, based on at least the respective magnitude of the respective second current phasor for each of the at least one piece of equipment of the one or more pieces of equipment, a respective second subset of lines of the EVSE network to which the respective piece of equipment is coupled; and
detect, based on a comparison of the respective subset of lines of the EVSE network and the respective second subset of lines of the EVSE network, a change in a topology of the EVSE network.

19. The processing system of claim 18, wherein the one or more processors are further configured to cause the processing system to:
modify a current limit of a first piece of equipment of the at least one piece of equipment based on the detected change in the topology of the EVSE network.

20. The processing system of claim 14, wherein the one or more processors are further configured to cause the processing system to:
increase a current limit of a first piece of equipment of the at least one piece of equipment based on the determined respective subset of lines of the EVSE network to which the respective piece of equipment is coupled.
